(19) United States
(12) Patent Application Publication
(10) Pub. No.: US 2006/0017885 A1
(43) Pub. Date: Jan. 26, 2006

(54) Image display by projecting optical source onto a rotating or moving surface

(76) Inventor: Francis Wah Nam Tang, Saratoga, CA (US)

Correspondence Address: Bo-In Lin, 13445 Mandoli Drive, Los Altos Hills, CA, 94022, US

(21) Appl. No.: 11/182,993

(22) Filed: Jul. 15, 2005

Related U.S. Application Data
(60) Provisional application No. 60/588,128, filed on Jul. 15, 2004.

(51) Int. Cl. G03B 21/00

(52) U.S. Cl. 353/13

(57) ABSTRACT

The present invention discloses a method for presenting an advertisement by displaying an image on a rotational or moving surface by projecting an image onto a rotational or moving surface. Since the image is not affixed onto the rotational or moving surface, the projected image can be viewed as a stationary image as the projected lights are reflected from the rotating or moving surface. Advertisements or different kinds of images can be presented on rotating surfaces such as rotating tires or rotating engine blades.

This Application is a Formal Application and claims a Priority Filing Date of Jul. 15, 2004 benefited from a previously filed Application No. 60/588,128 filed previously by the inventor of this Patent Application.

### BACKGROUND OF THE INVENTION

1. Field of the Invention

This invention relates generally to a system configuration and method for arranging an optical display on a moving subject. More particularly, this invention relates to a novel system configuration and method for projecting an advertisement from an image source as a public display on a rotational tire or other moving objects to effectively communicate and publicize advertisement messages.

2. Description of the Prior Art

Advertisements to propagate messages for commercial products and services are still limited by the technical difficulties that the images for public display are affixed to a displaying surface. Such public display may include images and words placed on a roadside billboard, a hood or side panel of a racecar or bus, or an electronic flashing billboard. Advertisement images implemented by these conventional technologies move with the display surfaces. For example, the commercial messages painted onto the side panels of a public transit bus move when a bus driver starts to drive the bus around a city block. Due to the nature of the display images, the conventional technologies of commercial message display impose a limitation that the human eyes can no longer view the advertisements clearly when a display surface moves at a speed beyond certain speed limit, e.g., human eyes can no longer see clearly an image on a tire that rotates at a high rotational speed.

However, with the advancement of modern technologies, there are ever-increased demands for such advertisement because there are more public events attracting large crowd gathered for viewing activities that involve high-speed movements. Events such as car races draw large crowds and are often nationally televised. Advertisements are placed on engine hood, side panels or other parts of the body to display the logos of a company or product names to publicize and propagate the commercial images and the public awareness. In the meantime, using the conventional method of image display, no images are placed on the tires of the racing cars due to the facts that the tires are rotating at very high speed and advertisement images fixed to the surface on the tire would also rotate with the tires. As a result, human eyes are not able to see clearly the advertisements placed on the rotating tires.

Therefore, a need still exists in the art of advertisements and image display to provide and establish new advertisement platforms to take full advantage of the modern display technologies to resolve such limitations. Specifically, modern display technologies may be implemented to display images for reflecting from a displaying surface while the images displayed are not affixed to and moving with a moving or rotational display surface such that the above-discussed limitations can be overcome.

### SUMMARY OF THE PRESENT INVENTION

It is therefore an object of the present invention to provide new and improved display systems to display commercial messages wherein the images and the messages are not painted or attached to a display surface. Instead the advertisement images are generated and projected from an image source and the projected optical images are reflected from a displaying surface. By removing the images as images affixed to a displaying surface and replacing the image display by projecting the image from an optical source onto a displaying surface. The images displayed on the displaying surface are viewed by human eyes as optical reflections from the displaying surface and thus are not substantially affected by instantaneous motion of the displaying surface.

Specifically, it is further an object of the present invention to provide new image display systems to project advertisement messages on a rotational surface by controlling an optical source to project an advertisement message on a moving surface observable by human eyes such that the projected advertisement message can be displayed not affected by a movement of the moving surface.

Briefly, in a preferred embodiment, the present invention discloses an image source disposed on a non-rotational part of a motor vehicle for projecting an optical image to a rotational part for display an image thereon. In a preferred embodiment, the optical source includes a laser image source for projecting visible laser beam for displaying the image.

In a preferred embodiment, this invention further discloses method for displaying an advertisement image and the method includes a step of projecting a display image from an image source and displaying the display image on a moving surface. The display image as projected from the image source is visible and recognizable by a viewer without being distorted or affected by the moving surface. In another preferred embodiment, the display image source is controlled by an image display controller to display the image with multiple color schemes and also for displaying the image with specific controlled timings to produce special advertisement and display effects.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIGS. 1A and 1B are a top view and a side cross sectional view of a wheel supporting a tire of this invention wherein an image source is mounted on a station shaft of the wheel for displaying an image on the wheel.

FIG. 2 is a perspective view of a racecar with image sources mounted on different parts of the car for projecting and displaying advertisements on the front or rear ties.

FIG. 3 is a functional block diagram for controlling the image source for projecting and displaying advertisement on different parts of a vehicle including tires.

### DETAILED DESCRIPTION OF THE PREFERRED EMBODIMENT

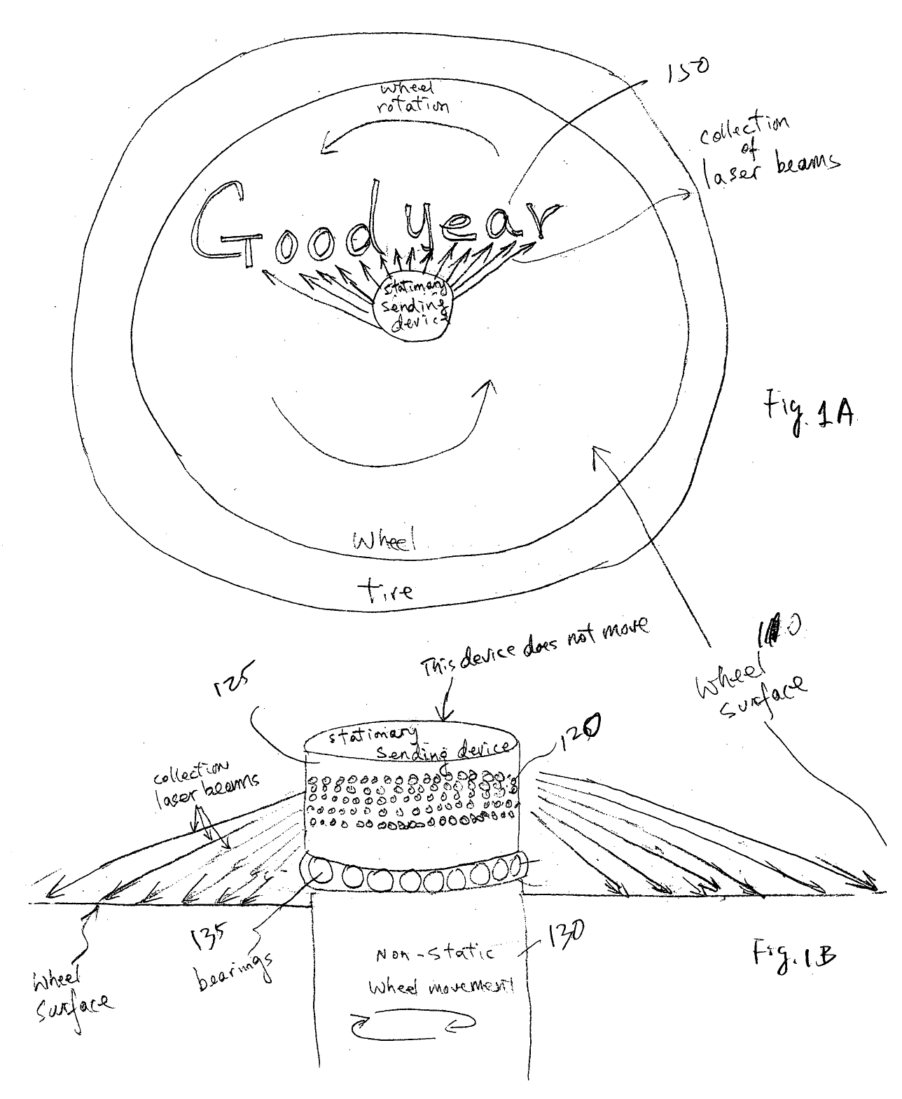

FIGS. 1A and 1B are a top view and a side cross sectional views of an image display system 100 of this invention for projecting and displaying images on a rotational wheel surface 110. The image display system includes an image source 120 disposed on a stationary cylindrical surface 125. The stationary cylindrical surface is mounted onto a rotational wheel shaft 130 with bearings 135 to isolate the stationary cylindrical surface 125 from the rotational wheel shaft 130 such that the stationary cylindrical surface 125 is not rotating with the rotational shaft 130. The image source 120 includes a plurality of laser beam source to project an optical image onto the rotational wheel surface 110. Since the image source 120 is stationary and rotating with the wheel, the images projected onto the wheel surface 110 are reflected from the rotating wheel surface as non-rotational images 150, e.g., Goodyear, to a viewer as that shown in FIG. 1A. A rotational surface, e.g., the wheel surface 110, is now useful for displaying a commercial message on a racecar wheel as an advertisement for an advertisement sponsor.

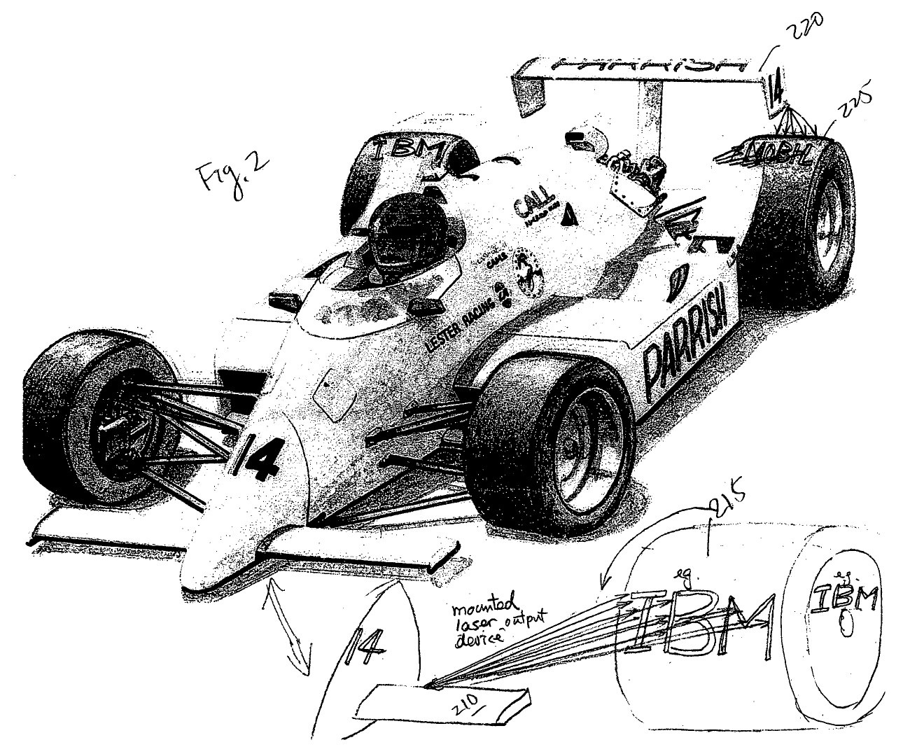

FIG. 2 shows another embodiment, for displaying advertisements on the surface of a tire of a racecar. As shown in FIG. 2, there are front and rear fenders 210 and 220 respectively. These fenders are near the front and rear tires 215 and 225 respectively. Image sources can be placed on the fenders 210 and 220 to project advertisement images onto the surface of the front and rear tires 215 and 225, e.g., IBM and Mobile. The advertisements projected onto the tire surface will not rotate with the rotating tires and would be visible to large crowds attending the car race events.

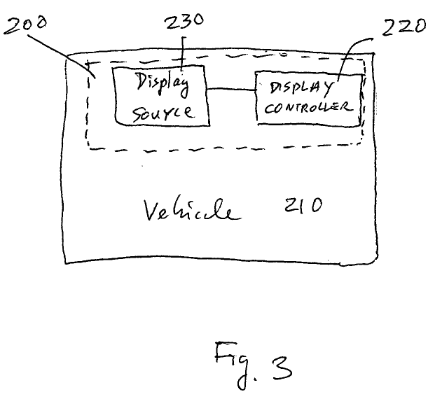

FIG. 3 is a functional block diagram for showing an optical image display system 200 installed on a vehicle 210 that includes a image display controller 220 for controlling an image display source 230. The control and display data signals may be transmitted to the image display source either through wired electrical connections or via wireless signal transmission. The image display source 230 has a processor to execute different display functions according to data and command signals receive from the image display controller 220. The image display controller 220 may send commands and data to control the color schemes and/ or timing of image display on the rotating surface of the tire with specially designed color schemes and timings to further increase the advertisement effects of the display images.

According to the drawings and above descriptions, this invention discloses an optical display system that includes an image projecting source disposed near a tire of a vehicle for projecting and displaying an image on a rotating surface of the tire. In a preferred embodiment, the image projecting source is disposed on a stationary shaft for supporting and linking the tire. In another preferred embodiment, the image projecting source is disposed on a stationary part of the vehicle for projecting and displaying an image on the rotating surface of the tire. In another preferred embodiment, the image projecting source further includes a laser image projecting source for projecting and displaying a laser image on a side surface of the rotating tire. In another preferred embodiment, the image projecting source further projecting an image to a rotating side surface of the tire for displaying an image on the rotating side surface of the tire. In another preferred embodiment, the optical display system further includes an image display controller for controlling the image projecting source for projecting and display an image on the rotating surface of the tire. In another preferred embodiment, the optical display system further includes an image display controller provided for receiving wireless data and control signals for controlling the image projecting source for projecting and display an image on the rotating surface of the tire. In another preferred embodiment, the image projecting source further includes an image source of multiple colors. In another preferred embodiment, the optical display system further includes an image display controller with a display time controller for controlling a timing of the image projecting source for projecting and display an image on the rotating surface of the tire. In another preferred embodiment, the optical display system further includes an image display controller with a display color controller for controlling a color scheme of the image projecting source for projecting and display an image on the rotating surface of the tire.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. An optical display system comprising:
an image projecting source disposed near a tire of a vehicle for projecting and displaying an image on a rotating surface of said tire.

2. The optical display system of claim 1 wherein:
said image projecting source is disposed on a stationary shaft for supporting and linking said tire.

3. The optical display system of claim 1 wherein:
said image projecting source is disposed on a stationary part of said vehicle for projecting and displaying an image on said rotating surface of said tire.

4. The optical display system of claim 1 wherein:
said image projecting source further comprising a laser image projecting source for projecting and displaying a laser image on a side surface of said rotating tire.

5. The optical display system of claim 1 wherein:
said image projecting source further projecting an image to a rotating side surface of said tire for displaying an image on said rotating side surface of said tire.

6. The optical display system of claim 1 further comprising:
an image display controller for controlling said image projecting source for projecting and display an image on said rotating surface of said tire.

7. The optical display system of claim 1 further comprising:
an image display controller provided for receiving wireless data and control signals for controlling said image projecting source for projecting and display an image on said rotating surface of said tire.

8. The optical display system of claim 1 wherein:
said image projecting source further comprising an image source of multiple colors.

9. The optical display system of claim 1 further comprising:
an image display controller with a display time controller for controlling a timing of said image projecting source for projecting and display an image on said rotating surface of said tire.

10. The optical display system of claim 1 further comprising:
an image display controller with a display color controller for controlling a color scheme of said image projecting source for projecting and display an image on said rotating surface of said tire.
